(19) United States
(12) Patent Application Publication
(10) Pub. No.: US 2017/0146954 A1
(43) Pub. Date: May 25, 2017

(54) TIMEPIECE COMPONENT

(71) Applicant: Nivarox-FAR S.A., Le Locle (CH)

(72) Inventor: Christian CHARBON, Chezard-St-Martin (CH)

(73) Assignee: Nivarox-FAR S.A., Le Locle (CH)

(21) Appl. No.: 15/284,762

(22) Filed: Oct. 4, 2016

(30) Foreign Application Priority Data
Nov. 19, 2015 (EP) 15195348.6

(51) Int. Cl. G04B 29/02; G04D 3/00; G04B 31/012

(52) U.S. Cl. CPC G04B 29/027; G04B 31/012; G04D 3/0074

(57) ABSTRACT

A timepiece component includes a core made of material suitable for electroforming, containing nickel-phosphorus or made of nickel-phosphorus, which core is, at least locally, coated with a surface layer of gold or gold alloy, to improve its tribological behaviour in areas including the surface layer of gold or gold alloy. The component is made by a fabrication method that includes the steps consisting in preparing a composition suitable for creating a solid core by a LIGA or electroforming method; shaping the solid core by a LIGA or electroforming method; coating the solid core, at least locally in areas subject to friction, with a gold or gold alloy surface layer.

This application claims priority from European Patent Application No. 15195348.6 filed on Nov. 19, 2015, the entire disclosure of which is hereby incorporated herein by reference.

### FIELD OF THE INVENTION

The invention concerns a timepiece component, comprising a core made of material suitable for electroforming, which core is, at least locally, coated with a surface layer of gold or gold alloy, to improve its tribological behaviour in the areas including said surface layer of gold or gold alloy.

The invention also concerns a method for fabricating a timepiece component.

The invention also concerns a watch comprising at least one such component.

The invention concerns the field of timepiece mechanisms, and in particular escapement mechanisms.

### BACKGROUND OF THE INVENTION

It is always difficult to ensure lubrication of timepiece mechanisms and to maintain lubrication over time. Degradation of the original lubricant generally means that watch users have to send the watches back for maintenance.

WO 2009/083487 in the name of NIVAROX-FAR SA discloses a method for fabricating a metal microstructure, by superposing at least two layers of different materials, in a UV-LIGA (Lithographie Galvanik Abformung) type method.

CH Patent 703794 in the name of SEIKO Instruments Inc. discloses the manufacture of a pallet-lever, with an electroformed guard pin.

CH Patent 681370 in the name of Estoppey-Reber and GET discloses a gold-based lubricating composition on a thin nickel-phosphorus layer.

### SUMMARY OF THE INVENTION

The invention proposes to improve the tribological behaviour of certain components of timepiece mechanisms, in particular escapement mechanisms.

To this end, the invention concerns a timepiece component according to claim 1.

The invention also concerns a watch comprising at least one such component.

The invention also concerns a method for fabricating a timepiece component according to claim 12.

### BRIEF DESCRIPTION OF THE DRAWINGS

Other features and advantages of the invention will appear upon reading the following detailed description, with reference to the annexed drawings, in which:

FIG. 1 shows a schematic plan view of a timepiece component, an escape wheel here, according to the invention.

FIG. 2 is a partial cross-section of the component of FIG. 1.

FIG. 3 is a diagram of the method according to the invention, with a first step of preparing a composition of material, a second step of shaping a core from the composition, and a third step of coating the core with a surface layer including gold, to form the component.

FIG. 4 and FIG. 5 are diagrams of variants of this method wherein a heat treatment step is performed after, respectively before, the step of coating the core with the surface layer.

FIG. 6 shows a schematic plan view of a watch including a component according to FIG. 1.

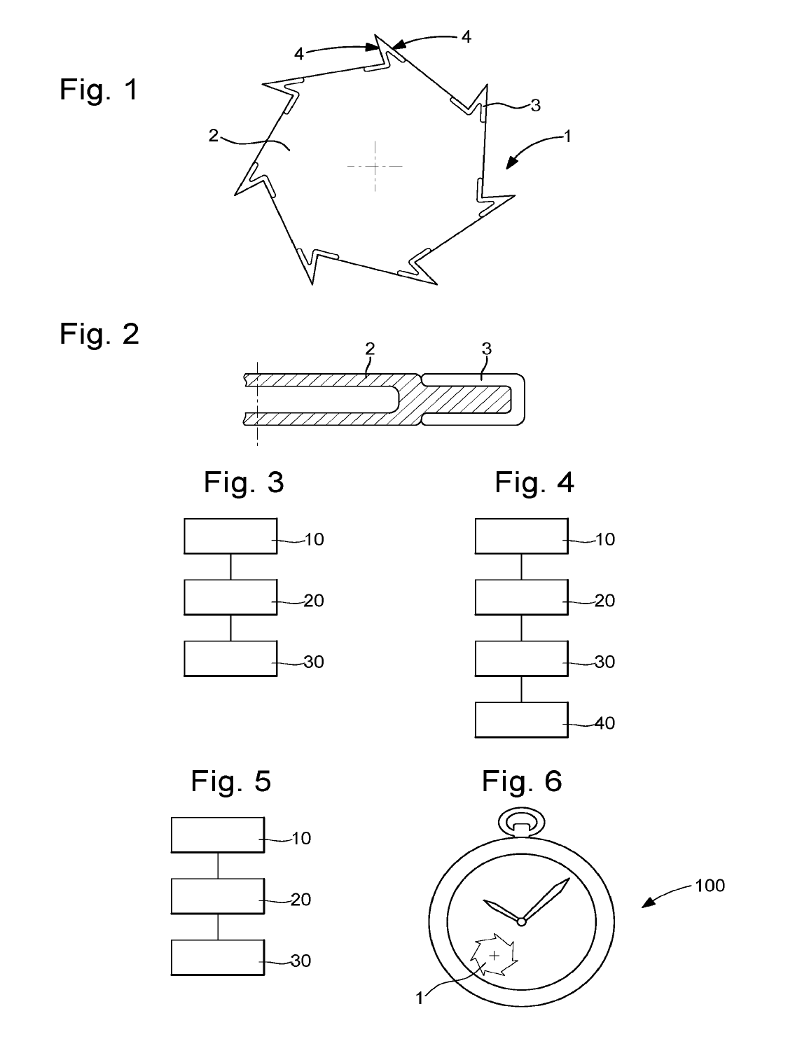

### DETAILED DESCRIPTION OF PREFERRED EMBODIMENTS

The invention concerns a timepiece component 1 with improved tribology.

This component 1 includes an electroformed core 2 made of a material suitable for electroforming, which core 2 is, at least locally, coated with a surface layer 3 of gold or gold alloy, to improve its tribological behaviour in the areas 4 including the surface layer 3 of gold or gold alloy.

According to the invention, core 2 is made of only one type of material, and the material of electroformed core 2 includes nickel.

More particularly, core 2 is hollow.

More particularly, the material of electroformed core 2 includes cobalt.

More particularly, the material of electroformed core 2 includes tungsten.

More particularly, the material of electroformed core 2 includes nickel-phosphorus (NiP).

More particularly, the material suitable for electroforming includes 8 to 15 mass percent of phosphorus in the nickel-phosphorus (NiP) contained therein.

More particularly, core 2 contains only nickel-phosphorus (NiP).

This variant embodiment wherein solid core 2 contains only nickel-phosphorus (NiP) is easy to implement, of reasonable cost and this material lends itself well to the adhesion of surface layer 3 of gold or gold alloy. More particularly, in this case core 2 has a thickness comprised between 40 micrometres and 1000 micrometres.

Preferably, core 2 is produced by an electroforming process, not described here since it is well known to those skilled in the art of horology/jewelery.

In a variant, core 2 is produced by a LIGA method.

More particularly, gold or gold alloy surface layer 3 is a layer having a thickness less than or equal to 1.0 micrometres.

More particularly, gold or gold alloy surface layer 3 is a layer of gold alloy containing at least 50 mass percent of gold.

More particularly, gold or gold alloy surface layer 3 is a layer of gold alloy containing at least 75 mass percent of gold.

More particularly, gold or gold alloy surface layer 3 is made of 18 carat gold alloy containing at least 75 mass percent of gold, and containing copper and silver.

More particularly, surface gold or gold alloy layer 3 is a layer of gold alloy containing a maximum of 77 mass percent of gold.

More particularly, surface gold or gold alloy layer 3 is a layer of gold alloy which may contain up to 100% gold. In a particular advantageous implementation of the invention, the deposited gold is virtually pure, and forms at least 99.0 mass percent of surface layer 3. The latter may also include traces of other materials, and more particularly contain traces of nickel or cobalt, with less than 0.5 mass percent of nickel and/or cobalt.

More specifically, component 1 is a movement component arranged to transmit a force and/or a torque by friction, such as a wheel, pinion, pallet lever (plate and/or guard pin and/or lifting pieces), impulse pin, spring element, or more particularly a component of an escapement mechanism, among the usual escapement components: balance, escape wheel, escape pinion, pallet lever, impulse pin.

The invention also concerns a watch 100 including at least one component 1 of this type.

The invention also concerns a method for manufacturing a timepiece component 1, which includes the steps consisting in:
Step 10: preparing a composition of material suitable for creating a solid core 2 by a LIGA or electroforming method;
Step 20: shaping solid core 2 by a LIGA or electroforming method;
Step 30: coating solid core 2, at least locally in areas 4 subject to friction, with a gold or gold alloy surface layer 3.

More particularly, the coating of solid core 2 with a gold or gold alloy surface layer 3 is effected over the entire surface of the core.

More particularly, the coating of solid core 2 with a gold or gold alloy surface layer 3 is achieved by an electroplating technique and/or PVD coating.

More particularly, after solid core 2 has been shaped and before or after solid core 2 is coated with a gold or gold alloy surface layer 3 to form a component 1, a heat treatment step 40 is effected on solid core 2 or on component 1.

More particularly, the coating of solid core 2 or of component 1 depending on the case, by a gold or gold alloy surface layer 3 is effected in the form of a surface layer 3 with a thickness less than or equal to 1.0 micrometres.

More particularly, surface layer 3 has a thickness comprised between 0.85 and 1.00 micrometres.

More particularly, the heat treatment is effected at a temperature comprised between 150° C. and 600° C. for a duration of between 30 minutes and 6 hours. More particularly, the heat treatment is effected at a temperature comprised between 150° C. and 600° C. for a duration of between 30 minutes and 6 hours. More particularly, this heat treatment is effected at a temperature comprised between 200° C. and 600° C.

More particularly, the heat treatment is a surface hardening heat treatment of solid core 2.

More particularly, the composition contains nickel, more particularly the composition is prepared with a nickel base.

More particularly, the composition contains nickel-phosphorus (NiP), more particularly the composition is prepared with a nickel-phosphorus (NiP) base.

More particularly, the composition includes 8 to 15 mass percent of phosphorus in the nickel-phosphorus (NiP) contained therein.

More particularly, the composition includes 13 to 15 mass percent of phosphorus in the nickel-phosphorus (NiP) contained therein.

More particularly, core 2 is made of only one type of material.

More particularly, the composition is prepared only with nickel-phosphorus (NiP).

More particularly, the composition contains cobalt and/or tungsten.

More particularly, the thickness of core 2 is comprised between 40 and 1000 micrometres. More particularly, the thickness of core 2 is comprised between 40 and 500 micrometres.

More particularly, the thickness of the nickel-phosphorus layer, if solid core 2 contains several layers of materials superposed on each other, is comprised between 1 and 50 micrometres.

More particularly, if solid core 2 contains several layers of materials superposed on each other, the layer receiving gold or gold alloy surface layer 3 is a nickel-phosphorus layer.

More particularly, component 1 is a movement component arranged to transmit a force and/or a torque by friction, such as a wheel, pinion, pallet lever (plate and/or guard pin and/or lifting pieces), impulse pin, spring element, or more particularly a component of an escapement mechanism, selected from a balance, escape wheel, escape pinion, pallet lever, impulse pin.

1. A timepiece component, comprising a core made of material suitable for electroforming, which core is, at least locally, coated with a surface layer of gold or gold alloy, to improve the tribological behaviour thereof in the areas including said surface layer of gold or gold alloy, wherein said core is made of a single type of material suitable for electroforming, which contains nickel.

2. The component according to claim 1, wherein said material suitable for electroforming contains cobalt.

3. The component according to claim 1, wherein said material suitable for electroforming contains tungsten.

4. The component according to claim 1, wherein said material suitable for electroforming contains nickel-phosphorus.

5. The component according to claim 4, wherein said material suitable for electroforming includes 8 to 15 mass percent of phosphorus in the nickel-phosphorus contained therein.

6. The component according to claim 5, wherein said material suitable for electroforming is made of nickel-phosphorus and contains from 8 to 15 mass percent of phosphorus, and in that said surface layer of gold or gold alloy contains at least 99.0 mass percent of gold.

7. The component according to claim 6, wherein said gold or gold alloy surface layer is a surface layer of thickness less than or equal to 1.0 micrometres.

8. The component according to claim 7, wherein said gold or gold alloy surface layer is made of 18 carat gold alloy containing at least 75 mass percent of gold, and containing copper and silver.

9. The component according to claim 8, wherein said surface layer includes at least 99.0 mass percent of gold.

10. The component according to claim 1, wherein said component is a component of a movement arranged to transmit a force and/or a torque by friction, from among a wheel, pinion, pallet lever, pallet plate, guard pin, lifting piece, impulse pin, spring element, or is a component of an escapement mechanism from among a balance, escape wheel, escape pinion, pallet lever, impulse pin.

11. A watch including at least one said component according to claim 1.

12. A method for fabricating a timepiece component, wherein said method includes the steps consisting of:
preparing a composition of material suitable for creating a solid core by a LIGA or electroforming method;
shaping said solid core by a LIGA or electroforming method;
coating said solid core, at least locally in areas subject to friction, with a gold or gold alloy surface layer.

13. The method according to claim 12, wherein the coating of said solid core with a gold or gold alloy surface layer is effected over the entire surface of said core.

14. The method according to claim 12, wherein the coating of said solid core with a gold or gold alloy surface layer is achieved by an electroplating technique and/or by PVD coating.

15. The method according to claim 12, wherein, after said solid core has been shaped and before or after said solid core is coated with a gold or gold alloy surface layer, a heat treatment step is effected on said solid core.

16. The method according to claim 12, wherein the coating of said solid core with a gold or gold alloy surface layer is effected with a thickness less than or equal to 1.0 micrometres.

17. The method according to claim 15, wherein said heat treatment is effected at a temperature comprised between 150° C. and 600° C. for a duration of between 30 minutes and 6 hours.

18. The method according to claim 12, wherein said composition is prepared with a nickel base.

19. The method according to claim 18, wherein said composition is prepared with from 8 to 15 mass percent of phosphorus in the nickel-phosphorus (NiP) contained therein.

20. The method according to claim 18, wherein said composition contains cobalt and/or tungsten.

21. The method according to claim 19, wherein said composition is prepared only with nickel-phosphorus.

22. The method according to claim 12, wherein said component is a component of a movement arranged to transmit a stress by friction, from among a wheel, pinion, pallet lever, pallet plate, guard pin, lifting piece, impulse pin, spring element, or is a component of an escapement mechanism from among a balance, escape wheel, escape pinion, pallet lever, impulse pin.
